(19) United States
(12) Patent Application Publication
(10) Pub. No.: US 2025/0016836 A1
(43) Pub. Date: Jan. 9, 2025

(54) COMMUNICATION DEVICE, COMMUNICATION METHOD, AND STORAGE MEDIUM

(71) Applicant: CANON KABUSHIKI KAISHA, Tokyo (JP)

(72) Inventor: MITSUYOSHI YUKAWA, Kanagawa (JP)

(21) Appl. No.: 18/894,477

(22) Filed: Sep. 24, 2024

Related U.S. Application Data
(63) Continuation of application No. PCT/JP2023/010500, filed on Mar. 17, 2023.

(30) Foreign Application Priority Data
Mar. 28, 2022 (JP) 2022-052635

(51) Int. Cl. H04W 74/0816; H04W 74/08; H04W 76/10; H04W 84/12

(52) U.S. Cl. CPC H04W 74/0816; H04W 74/0866; H04W 76/10; H04W 84/12

(57) ABSTRACT

A Trigger frame is transmitted that allows at least one of other communication devices participating in a wireless network to share a first period and communicate, the Trigger frame being compliant with an IEEE 802.11 series standard, the first period being at least a portion of a Transmission Opportunity (TXOP) acquired by a communication device that establishes the wireless network. By transmitting a confirmation frame, it is confirmed whether or not a first other communication device is ready for communication during the first period, the first other communication being included in the other communication devices that participate in the wireless network and being not allowed to share the first period by the transmitted Trigger frame. In a case where the first other communication device is not ready for communication during the first period, a frame is not transmitted to the first other communication device during the first period.

### CROSS-REFERENCE TO RELATED APPLICATIONS

This application is a Continuation of International Patent Application No. PCT/JP2023/010500, filed Mar. 17, 2023, which claims the benefit of Japanese Patent Application No. 2022-052635, filed Mar. 28, 2022, both of which are hereby incorporated by reference herein in their entirety.

### TECHNICAL FIELD

The present disclosure relates to wireless communication technology.

### BACKGROUND ART

Standards of wireless local area network (LAN) technology have been developed by IEEE 802.11, a standards organization for wireless LAN technology. The standards of wireless LAN technology include IEEE 802.11/a/b/g/n/ac/ax, for example. In this case, IEEE is an abbreviation for Institute of Electrical and Electronics Engineers.

IEEE 802.11ax, described in PTL 1, uses orthogonal frequency-division multiple access (OFDMA) to achieve a high peak throughput of up to 9.6 gigabits per second (Gbps) as well as improved communication speed under congested conditions. Note that OFDMA is an abbreviation for orthogonal frequency-division multiple access.

To further improve throughput, a Task Group was formed to develop the IEEE 802.11be standard, which is a successor to IEEE 802.11ax.

A task group called IEEE 802.11be was formed, IEEE 802.11be being a successor standard to further improve throughput, frequency utilization efficiency, and communication latency. In the IEEE 802.11be standard, for example, Multi-Link communication is being studied, in which one access point (AP) establishes multiple links with one station (STA) via multiple different frequency channels and communicates in parallel.

In IEEE 802.11be, Triggered TXOP sharing is proposed, in which a portion of a TXOP acquired by an AP is shared with STAs participating in the network using a Trigger frame. In this case, TXOP is an abbreviation for Transmission Opportunity. The TXOP acquired by the AP is shared with a STA designated by the AP, and undesignated STAs are prohibited to transmit frames during the shared TXOP, thereby preventing unnecessary transmission frame collisions and enabling efficient communication to be performed.

### CITATION LIST

### Patent Literature

PTL 1 Japanese Patent Laid-Open No. 2018-50133

As described above, a method to improve communication efficiency by sharing a TXOP acquired by an AP with designated STAs is being studied. However, there are no provisions regarding the behavior of STAs with which a TXOP is not shared, and there is a risk that an AP and STAs with which the TXOP is shared might not be able to exchange frames properly.

Therefore, the purpose of a communication device according to the present disclosure is to ensure that frames can be properly communicated among an AP and STAs in communications in which a TXOP acquired by the AP is shared with the STAs, which are designated.

### SUMMARY OF INVENTION

In order to solve the above problem, a communication device according to the present disclosure is a communication device that operates in a role of establishing a wireless network and includes a transmission unit that transmits a Trigger frame that allows at least one of other communication devices participating in the wireless network to share a first period and communicate, the Trigger frame being compliant with an IEEE 802.11 series standard, the first period being at least a portion of a Transmission Opportunity (TXOP) acquired by the communication device, and a confirmation unit that confirms, by transmitting a confirmation frame, whether or not a first other communication device is ready for communication during the first period, the first other communication being included in the other communication devices that participate in the wireless network and being not allowed to share the first period by the Trigger frame transmitted by the transmission unit. In a case where it is confirmed by the confirmation unit that the first other communication device is not ready for communication during the first period, a frame is not transmitted to the first other communication device during the first period.

Moreover, a communication device according to the present disclosure includes a reception unit that receives a Trigger frame that allows at least one of communication devices participating in a wireless network to share a first period and communicate, the first period being at least a portion of a Transmission Opportunity (TXOP) acquired by another communication device playing a role of establishing the wireless network, the Trigger frame being compliant with an IEEE 802.11 series standard, and a transmission unit that transmits, in a case where the communication device is not allowed to share the first period by the Trigger frame received by the reception unit, a response frame for a confirmation frame, which is transmitted from the other communication device, to the other communication device.

Further features of the present invention will become apparent from the following description of exemplary embodiments with reference to the attached drawings.

### BRIEF DESCRIPTION OF DRAWINGS

FIG. 1 is a diagram illustrating an example of the configuration of a network established by a communication device 101.

FIG. 2 is a diagram illustrating the hardware configuration of communication devices 101 to 105.

FIG. 3 is a diagram illustrating an example of a functional configuration of the communication devices 101 to 105.

FIG. 4 is a diagram illustrating a sequence diagram for confirming whether a STA to which a TXOP acquired by an AP is not allocated in Embodiment 1 is ready for communication.

FIG. 5 is a flowchart for describing the operation of the AP in Embodiment 1.

FIG. 6 is a diagram illustrating a sequence diagram for confirming whether a STA to which a TXOP acquired by an AP is not allocated in Embodiment 2 is ready for communication.

FIG. 7 is a flowchart for describing the operation of the AP in Embodiment 2.

FIG. 8 is a flowchart of a TXOP process in Embodiment 2.

### DESCRIPTION OF EMBODIMENTS

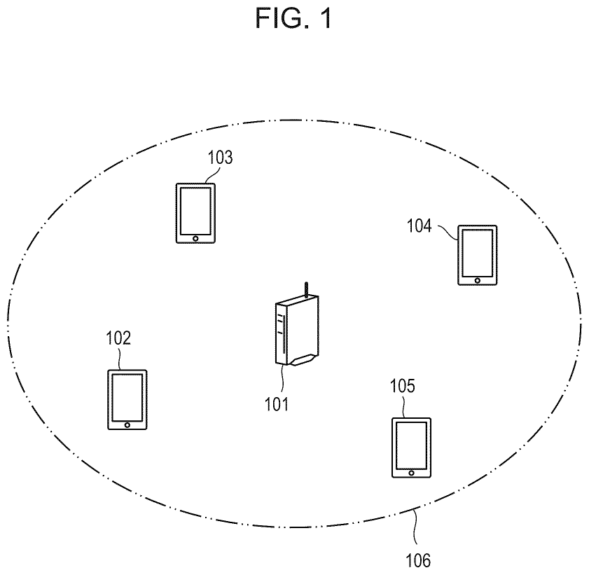

FIG. 1 is a diagram illustrating an example of the configuration of a network in which a communication device 101 according to the present embodiment participates. The communication device 101 can communication with communication devices 102 to 105. The communication device 101 is an access point (AP) that has the role of establishing a wireless network 106, and the communication devices 102 to 105 are stations (STAs) that have the role of participating in the wireless network 106.

Each of the communication devices 101 to 105 can perform wireless communication compliant with the IEEE 802.11be standard. Note that IEEE is an abbreviation for Institute of Electrical and Electronics Engineers. The communication devices 101 to 105 can communicate in 2.4 GHz, 5 GHZ, and 6 GHz frequency bands. In addition, the communication devices 101 to 105 can communicate using bandwidths of 20 MHZ, 40 MHZ, 80 MHZ, 160 MHZ, and 320 MHZ.

The communication devices 101 to 105 can realize multi-user (MU, Multi User) communication, in which signals of multiple users are multiplexed, by performing OFDMA communication compliant with the IEEE 802.11be standard. OFDMA is an abbreviation for Orthogonal Frequency Division Multiple Access. In OFDMA communication, a portion of the divided frequency band (RU, Resource Unit) is allocated to each STA so that the allocated portions do not overlap each other, and the carrier waves of the STAs are orthogonal to each other. Thus, the AP can communicate with the multiple STAs in parallel.

Note that the communication devices 101 to 105 support the IEEE 802.11be standard but may also support legacy standards that pre-date the IEEE 802.11be standard. Specifically, the communication devices 101 to 105 may support at least one of the IEEE 802.11a/b/g/n/ac/ax standards. Alternatively, the communication devices 101 to 105 may also support a successor standard to the IEEE 802.11be.

In addition to the IEEE 802.11 series standards, the communication devices 101 to 105 may support other communication standards such as Bluetooth®, NFC, UWB, ZigBee, and MBOA, for example.

Note that UWB is an abbreviation for Ultra-Wide Band, and MBOA is an abbreviation for Multi Band OFDM Alliance. NFC is an abbreviation for Near Field Communication. UWB includes wireless USB, wireless 1394, and WiNET, for example. Moreover, the communication devices 101 to 105 may also support communication standards for wired communications, such as wired LAN.

Specific examples of the communication devices 101 to 105 include, but are not limited to, wireless LAN routers and personal computers (PCs). The communication devices 101 to 105 may also be information processing devices such as wireless chips that can perform wireless communication compliant with the IEEE 802.11be standard. Specific examples of the communication devices 102 to 105 include, but are not limited to, cameras, tablets, smartphones, PCs, cell phones, and video cameras. The wireless network in FIG. 1 is constituted by one AP and three STAs, but the number of APs and that of STAs are not limited to these. The technique of allocating and sharing portions of the Transmission Opportunities (TXOPs) acquired by APs to and with STAs using a Trigger Frame is called Triggered TXOP sharing. TXOPs refer to the periods of time during which APs or STAs are allowed to exclusively use channels after obtaining access to the channels through contention control based on EDCA. In this case, EDCA is an abbreviation for Enhanced Distributed Channel Access. An AP allocates a portion of the acquired TXOP to a STA through Triggered TXOP sharing to allow the STA to share the TXOP acquired by the AP. Hereinafter, the TXOP that is acquired by an AP and that can be shared with and used by a STA or STAs is referred to as a TXOP sharing period.

Triggered TXOP sharing is initiated when the AP transmits an MU-RTS TXS Trigger frame to STAs. In this case, MU-RTS TXS Trigger frame is an abbreviation for Multi User-Request to Send TXOP sharing Trigger Frame. In this case, in the User Info field of the MU-RTS TXS Trigger frame, the AP includes the association identifiers (AIDS) of STAs that the AP allows to share a portion of the secured TXOP and perform communication. Note that, in Triggered TXOP sharing, an MU-RTS TXS Trigger frame is used in which Trigger Type of the Trigger frame is set to MU-RTS.

The STA that is allocated a portion of the TXOP acquired by the AP by the MU-RTS TXS Trigger frame can transmit data to the AP or another STA during the TXOP sharing period. Whether communication between the STA and the AP or between the STA and the other STA is performed during the TXOP sharing period can be specified through the TXOP sharing mode subfield included in the Common Info field of the above-described Trigger frame.

### Configurations of AP and STA

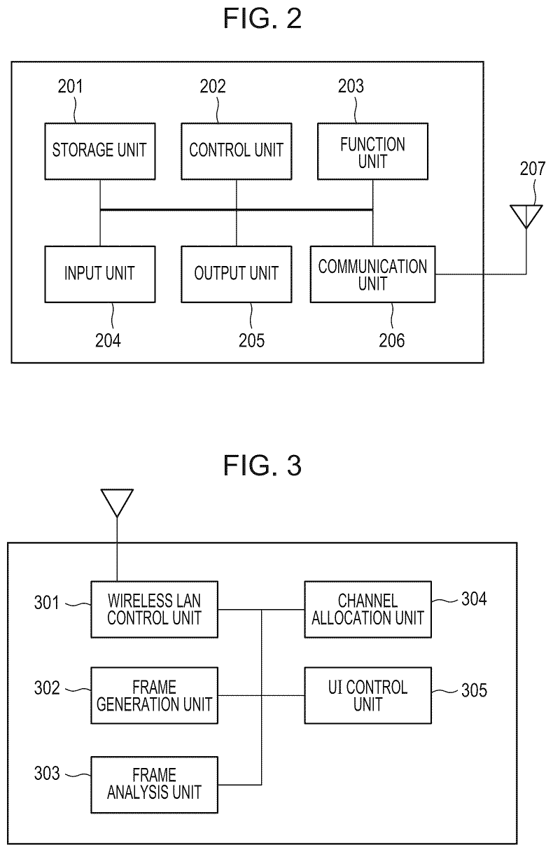

FIG. 2 illustrates an example of the hardware configuration of the communication device 101, which is an AP in the present embodiment. Note that the same configuration can be used for the communication devices 102 to 105, which are STAs. The communication device 101 includes a storage unit 201, a control unit 202, a function unit 203, an input unit 204, an output unit 205, a communication unit 206, and an antenna 207.

The storage unit 201 is constituted by a memory, such as a read-only memory (ROM) or random access memory (RAM), and stores various information such as computer programs for performing various operations described below and communication parameters for wireless communication. ROM is an abbreviation for Read Only Memory, and RAM is an abbreviation for Random Access Memory. Note that, in addition to memories such as ROMs and RAMs, storage media such as flexible disks, hard disks, optical disks, magneto-optical disks, CD-ROMs, CD-Rs, magnetic tapes, non-volatile memory cards, and DVDs, for example, may also be used as the storage unit 201. The storage unit 201 may include multiple memories, for example.

The control unit 202 is constituted by one or more processors, such as a central processing unit (CPU) or a microprocessing unit (MPU), and controls the entirety of a communication device 101 by executing a computer program stored in the storage unit 201. CPU is an abbreviation for Central Processing Unit, and MPU is an abbreviation for Micro Processing Unit. Note that the control unit 202 may control the entire communication device 101 in cooperation with the computer programs stored in the storage unit 201 and the operating system (OS). The control unit 202 generates data and signals to be transmitted in communication with other communication devices. The control unit 202 may include multiple processors, such as multi-core processors, and the entire communication device 101 may be controlled by the multiple processors. Moreover, the control unit 202 controls the function unit 203 to perform predetermined processes, such as wireless communication, image capture, printing, and projection. The function unit 203 is hardware for the communication device 101 to perform the predetermined processes.

The input unit 204 accepts various operations from the user.

The output unit 205 provides various outputs to the user via a monitor screen and speakers. In this case, outputs from the output unit 205 may be displayed on the monitor screen, may be audio outputs through the speakers, vibration outputs, and so forth. Note that both the input unit 204 and the output unit 205 may be realized in one module, as in the case of a touch panel. The input unit 204 and the output unit 205 may each be integrated with the communication device 101 or may each be provided separately from the communication device 101.

The communication unit 206 controls wireless communication compliant with the IEEE 802.11be standard. The communication unit 206 may also control wireless communication compliant with other IEEE 802.11 series standards in addition to the IEEE 802.11be standard and also control wired communication, such as wired LAN. The communication unit 206 controls the antenna 207 to transmit and receive radio signals for wireless communication generated by the control unit 202.

Note that, in a case where the communication device 101 supports, for example, the NFC and Bluetooth standards in addition to the IEEE 802.11be standard, the communication device 101 may control wireless communication compliant with these communication standards. In a case where the communication device 101 can perform wireless communication compliant with multiple communication standards, the communication device 101 may be configured with communication units 206 and antennas 207 supporting the respective communication standards. The communication device 101 communicates image data, document data, video data, and other data with the communication devices 102 to 105 via the communication units 206.

FIG. 3 illustrates a block diagram of the functional configuration of the communication device 101, which is an AP in the present embodiment. Note that the same configuration can be used for the communication devices 102 to 105, which are STAs. In this case, the number of wireless LAN control units 301 in the AP 101 is not limited to one, but may be two or more. The AP 101 further includes a frame generation unit 302, a frame analysis unit 303, a channel allocation unit 304, and a user interface (UI) control unit 305.

A wireless LAN control unit 301 includes an antenna and a circuit for transmitting and receiving radio signals to and from other wireless LAN devices and a program for controlling the antenna and circuit. The wireless LAN control unit 301 performs wireless LAN communication control with frames generated by the frame generation unit 302 in accordance with the IEEE 802.11 standard series.

The frame generation unit 302 generates wireless control frames to be transmitted by the wireless LAN control unit 301. Details of a wireless control frame generated by the frame generation unit 302 may be constrained by settings stored in the storage unit 201. The details of wireless control may also be changed in accordance with user settings from the UI control unit 305.

The frame analysis unit 303 interprets frames received by the wireless LAN control unit 301, and reflects the content of the frames in the wireless LAN control unit 301. Regardless of which control unit receives a frame, once the frame is passed through the frame analysis unit 303, it is possible to control a wireless LAN control unit that has not received the frame.

When instructing communication with a communication partner or communication with a STA, the channel allocation unit 304 performs determinations to appropriately allocate a channel for the AP and STA to communicate. In accordance with the allocation determined in this case, for example, the AP 101 and the STA 102 communicate through a channel or a sub-channel specified therein.

The UI control unit 305 includes hardware devices related to user interfaces, such as a touch panel or buttons for accepting operations performed for the AP by a user (not illustrated) of the AP, and programs for controlling the hardware devices. Note that the UI control unit 305 also has the function of presenting information to the user, for example, displaying images and so forth or outputting audio and so forth.

### Embodiment 1

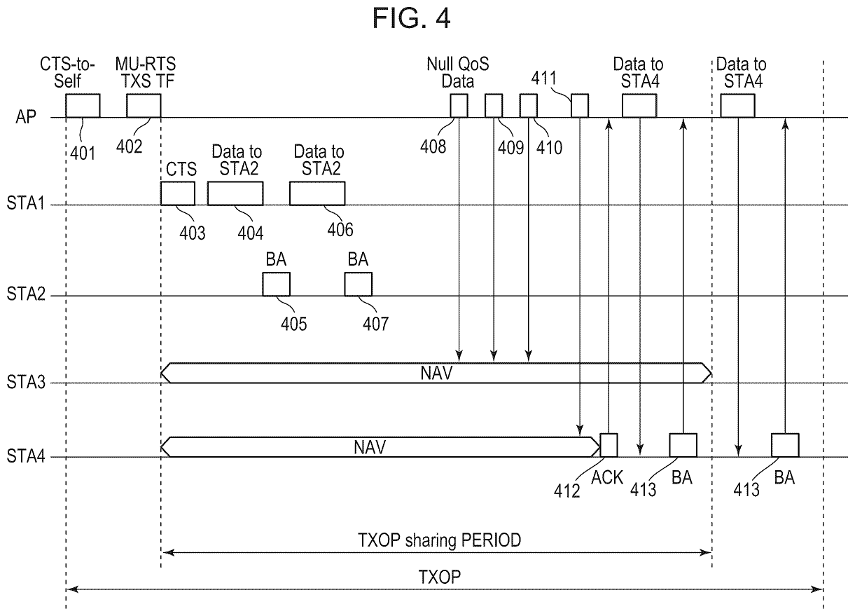

FIG. 4 is a sequence diagram illustrating an example in which an AP confirms whether or not a STA that is not allowed to share a TXOP is ready for communication during a TXOP sharing period. In the present embodiment, the TXOP acquired by the AP is shared between STA1 and STA2, and communication is performed between STA1 and STA2 during the TXOP sharing period. STA3 and STA4 are not allowed to share the TXOP acquired by the AP, and thus network allocation vectors (NAVs) are set during the TXOP sharing period.

The AP acquires a TXOP by transmitting a CTS-to-self frame 401. The AP then transmits a MU-RTS TXS Trigger frame 402 to STA1 to STA4. The MU-RTS TXS Trigger frame includes a TXOP sharing Mode subfield. When the subfield is 1, it indicates a mode in which a STA transmits PPDUs to the AP. In this case, PPDU is an abbreviation for PLCP Protocol Data Unit, and PLCP is an abbreviation for Physical Layer Convergence Protocol. When the subfield is 2, it indicates a mode in which a STA transmits PPDUs to the AP or another STA sharing the TXOP. In the present embodiment, the TXOP Sharing Mode subfield is 2, and this indicates that communication is performed between STAs. In the present embodiment, STA1 and STA2 are allowed to share the TXOP sharing period, which is a portion of the TXOP acquired by the AP, and to perform communication during this period. STA3 and STA4 are not allowed to share the TXOP sharing period and perform communication.

STA1 having received the frame 402 confirms, through the frame 402, that the TXOP sharing period is allocated thereto, and then transmits a CTS frame 403, which is a response frame for the frame 402, to the AP. In this case, whether or not the TXOP sharing period is allocated to a STA is determined by confirming whether or not the User Info field in the frame 402 includes the AID of the STA.

After transmitting the CTS frame 403, STA1 transmits data 404 to STA2. For STA3 and STA4, to which the TXOP sharing period is not allocated, network allocation vectors (NAVs) are set on the basis of Duration information in the received MU-RTS TXS Trigger frame 402 or CTS frame 403. In this case, the NAVs for STA3 and STA4 are set to be of equal length.

In a case where the AP detects that there is no communication between STA1 and STA2 over a certain period of time during the TXOP sharing period, the AP transmits a Null QOS Data frame 408 to STA3, for which the NAV is set. The Null QOS Data frame 408 is a confirmation frame to confirm whether or not STA3, for which the NAV is set, is ready for communication during a TXOP sharing period.

In a case where the AP does not receive a response frame from STA3, the AP then retransmits a Null QoS Data frame 409. In FIG. 4, the Null QOS Data frame is transmitted three times, and in a case where the AP does not receive a response frame even once, it is determined that STA3 is not ready for communication. The number of times the Null QOS Data frame is transmitted is not limited to three. It may be set to determine that STA3 is not ready for communication in a case where no response frame is received even after transmitting the Null QOS Data frame a predetermined number of times.

In a case where it is determined that STA3 is not ready for communication, the AP does not transmit data to STA3 but transmits a Null QOS Data frame 411 to STA4 to transmit data to STA4, which is not allowed to share the TXOP. In the present embodiment, STA3 cannot respond to a confirmation frame because the NAV is set for STA3 and STA3 is in the Power save state, but STA4 can respond because STA4 is in the Awake state during the period where the NAV is set. Thus, STA4 cancels the set NAV and transmits, to the AP, a response frame 412 for the Null QOS Data frame 411. By receiving the response frame 412 from STA4, the AP determines that STA4 is ready for communication and transmits a data frame to STA4.

In the present embodiment, Null QOS Data frames were transmitted in the order of STA3 and STA4, but the order is not limited to this. For example, the order in which Null QOS Data frames are transmitted may be determined by the amount of data to be transmitted or may be determined randomly.

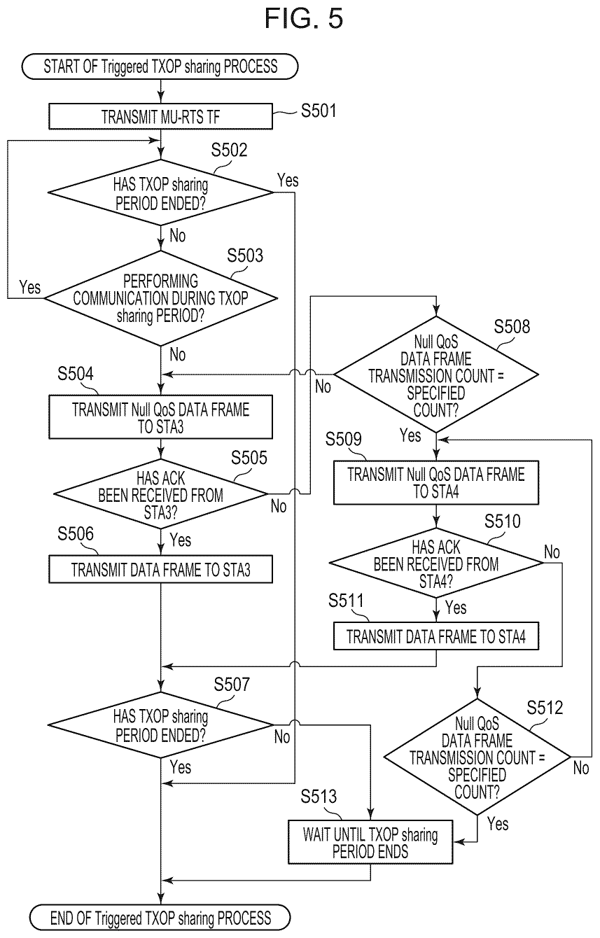

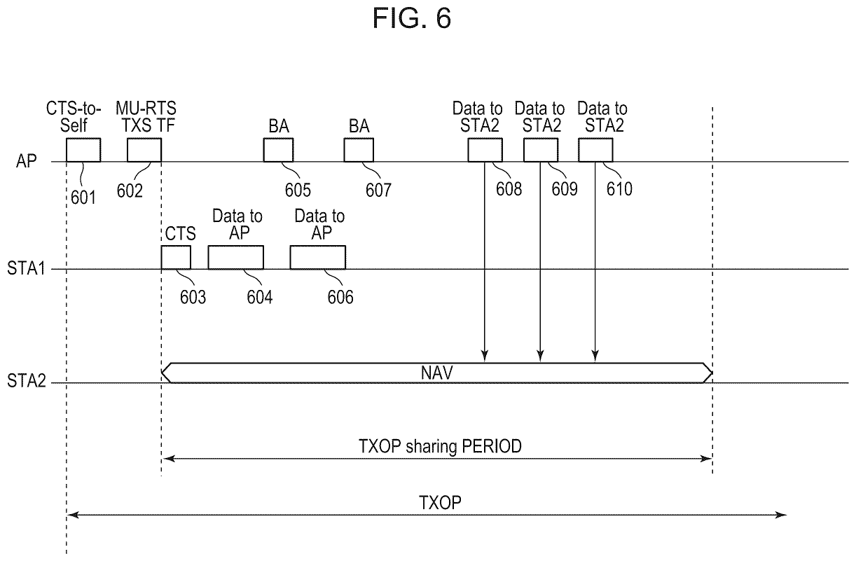

FIG. 5 is used to describe a process performed when TXOP sharing is performed by the control unit 202 executing the program stored in the storage unit 201 of the communication device 101, which is the AP. This flowchart is initiated when the AP starts DLMU or Triggered TXOP sharing communication.

Transmitting a MU-RTS TXS Trigger Frame causes STA1 and STA2, which are allowed to share the TXOP acquired by the AP, to set up Triggered TXOP sharing (S501). In the present embodiment, STA1 and STA2 are allowed to transmit frames during the TXOP sharing period, but STA3 and STA4 are not allowed to transmit frames during the TXOP sharing period.

After the MU-RTS TXS Trigger frame is transmitted in S501, it is determined whether or not the TXOP sharing period has ended (S502). In a case where it is determined in S502 that the TXOP sharing period has ended, this flowchart ends.

In a case where it is determined in S502 that the TXOP sharing period has not ended, it is determined whether or not the state of not performing communication during the TXOP sharing period has continued over a certain period of time (S503).

In a case where it is determined in S503 that the state of not performing communication has continued over a certain period of time, a Null QOS Data frame is transmitted to STA3, to which TXOP is not allocated, to determine whether or not STA3 is ready for communication (S504). In the present embodiment, a Null QOS Data frame is transmitted in S504, but what is transmitted is not limited to this. For example, an RTS frame may be transmitted instead of a Null QOS Data frame to determine whether or not STA3 is ready for communication.

In a case where it is determined that an ACK frame, which is a response frame for the Null QOS Data frame transmitted in S504, has been received from STA3 (S505), a data frame is transmitted to STA3 (S506). After transmitting the data frame, it is determined whether or not the TXOP sharing period has ended (S507). In a case where it is determined that the TXOP sharing period has ended, this flowchart ends.

In a case where it is determined in S505 that an ACK frame is not received from STA3, it is determined whether or not the Null QOS Data frame has been transmitted a predetermined number of times (S508).

In a case where it is determined in S508 that the Null QOS Data frame has not been transmitted the predetermined number of times, the Null QOS Data frame is transmitted to STA3 again. In a case where it is determined in S508 that the Null QOS Data frame has been transmitted the predetermined number of times, the Null QOS Data frame is transmitted to STA4, to which the TXOP is not allocated (S509).

In a case where it is determined that an ACK frame, which is a response frame for the Null QOS Data frame transmitted in S509, has been received from STA4 (S510), a data frame is transmitted to STA4 (S511). After transmitting the data frame, it is determined whether or not the TXOP sharing period has ended (S507). In a case where it is determined that the TXOP sharing period has not ended, a process in S513 is performed, and in a case where it is determined that the TXOP sharing period has ended, this flowchart ends.

In a case where it is determined in S510 that an ACK frame is not received from STA4, it is determined whether or not the Null QOS Data frame has been transmitted a predetermined number of times (S512).

In a case where it is determined in S512 that the Null QOS Data frame has not been transmitted the predetermined number of times, the Null QOS Data frame is transmitted to STA4 again. In a case where it is determined in S512 that the Null QOS Data frame has been transmitted the predetermined number of times, the AP waits until the TXOP sharing period ends (S513). When the TXOP sharing period ends, this flowchart ends.

According to the present embodiment, when transmitting data to a STA to which a TXOP is not allocated during the TXOP sharing period, it becomes possible to confirm whether or not the STA is ready for communication by transmitting a Null QOS Data frame. By confirming whether or not a STA to which a TXOP is not allocated is ready for communication, for example, the STA can suppress packet loss of data frames from the AP.

### Embodiment 2

In Embodiment 1, the example is illustrated in which it is confirmed whether or not a STA to which a TXOP is not allocated is ready for communication during the TXOP sharing period by transmitting a Null QOS Data frame. In the present embodiment, an example is illustrated in which it is confirmed whether or not a STA to which a TXOP is not allocated is ready for communication during the TXOP sharing period by transmitting a data frame.

FIG. 6 is a sequence diagram illustrating an example in which it is confirmed whether or not a STA to which a TXOP is not allocated is ready for communication in communication performed using TXOP sharing. In the present embodiment, the TXOP acquired by the AP is allocated to STA1, and communication is performed between STA1 and the AP during the TXOP sharing period. The TXOP acquired by the AP is not allocated to STA2.

The AP acquires a TXOP by transmitting a CTS-to-self frame 601. The AP then transmits a MU-RTS TXS Trigger frame 602 to STA1 and STA2.

STA1 having received the MU-RTS TXS Trigger frame 602 confirms, through the frame 602, whether or not the TXOP acquired by the AP is allocated to STA1. In a case where the TXOP acquired by the AP is allocated to SAT1, SAT1 transmits a CTS frame 603, which is a response frame for the frame 602, to the AP. In this case, whether or not the TXOP sharing period is allocated to a STA is determined by confirming whether or not the User Info field in the frame 602 includes the AID of the STA.

After transmitting the CTS frame 603, STA1 transmits data 604 to the AP. For STA2, to which the TXOP acquired by the AP is not allocated, a NAV is set on the basis of Duration information in the received MU-RTS TXS Trigger frame 602 or CTS frame 603.

When STA1 transmits a PPDU 604 to the AP, the AP that has received the PPDU 604 transmits Block Ack 605 to STA1. In a case where there are more PPDUs to be transmitted, STA1 transmits a PPDU 606 to the AP, and the AP transmits Block Ack 607 to STA1.

In a case where the AP detects that there is no communication with STA1 over a certain period of time during the TXOP that the AP allocated, the AP transmits a Data frame 608 to STA2, to which the TXOP is not allocated and for which an NAV is set. The Data frame 608 is a confirmation frame for confirming whether or not STA2, for which an NAV is set, is ready for communication.

In this case, “there is no communication with STA1 over a certain period of time during the TXOP that the AP allocated” means, for example, that the STA completes the transmission of data to be transmitted to the AP before the end of the TXOP sharing period or that the STA fails to transmit data before completing transmission of the data.

In the present embodiment, suppose that STA2 is not ready for communication during the TXOP sharing period and cannot receive data frames transmitted from the AP.

In a case where the AP does not receive an Ack frame, which is transmitted from STA2 to the AP, for a Data frame 608, the AP retransmits a Data frame 609, which is the same as the Data frame 608, to STA2. In this case, as an existing technology, there is a mechanism to retransmit a data frame up to a specified number of times in a case where an Ack frame for a data frame is not received. In the present embodiment, the maximum transmission count for the data frame is set smaller than that in the existing technology, and thus the number of times transmission of the data frame fails can be kept lower. In a case where the data frame is transmitted up to the preset predetermined maximum number of times and the AP still does not receive an Ack frame, the AP determines that STA2 is not ready for communication. In a case where it is determined that STA2 is not ready for communication, the AP waits without transmitting data to STA2 until the TXOP sharing period ends. After the TXOP sharing period ends, the AP may transmit data frames to STA2 on a priority basis.

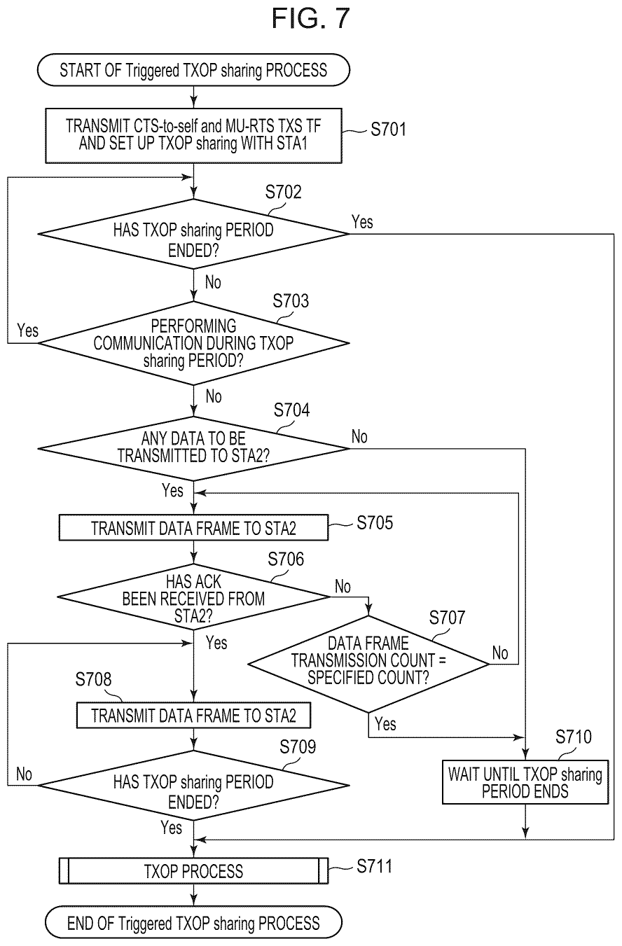

FIG. 7 is used to describe a process performed when TXOP sharing is performed by the control unit 202 executing the program stored in the storage unit 201 of the communication device 101, which is the AP. This flowchart is initiated when the AP starts DLMU or Triggered TXOP sharing communication.

By the AP transmitting a MU-RTS TXS Trigger Frame, Triggered TXOP sharing is set up with STA1, which has been allowed to share the TXOP (S701).

In a case where it is determined that the TXOP sharing period has not ended (S702), it is determined whether or not the state of not performing communication during the TXOP sharing period has continued for a certain period of time (S703). In a case where it is determined in S703 that the state of not performing communication during the TXOP sharing period has continued for a certain period of time, it is determined whether or not there is data to be transmitted to STA2, to which the TXOP is not allocated (S704).

In a case where it is determined in S704 that there is a Data frame to be transmitted to STA2, the Data frame is transmitted to STA2 (S705).

In a case where it is determined in S704 that there are no Data frames to be transmitted to STA2, the AP waits until the TXOP sharing period ends (S710) and then this flowchart ends.

It is determined whether or not an ACK, which is a response frame for the Data frame transmitted in S705, has been received (S706). In a case where it is determined in S706 that an ACK has not been received, it is determined whether or not the frame has been transmitted a predetermined number of times (S707). In this case, the maximum number of retransmissions for the frame in the present embodiment is set smaller than that for the existing frame retransmission techniques. In a case where it is determined in S707 that the Data frame has not been transmitted the predetermined number of times, the Data frame is transmitted to STA2 again. In a case where it is determined in S707 that the Data frame has been transmitted the predetermined number of times, the AP waits until the TXOP sharing period ends (S710). When the TXOP sharing period ends, this flowchart ends.

In a case where it is determined in S706 that an ACK has been received, in a case where there is data to be transmitted, a data frame is transmitted to STA2 until the TXOP sharing period ends (S708).

The AP determines whether or not the TXOP sharing period has ended (S709). In a case where the AP determines that the TXOP sharing period has ended, the process proceeds to a TXOP process in S711.

In the present embodiment, data transmission is continued in the TXOP process (S711) in a case where the AP still has data to transmit to STA2 at the end of the TXOP sharing period.

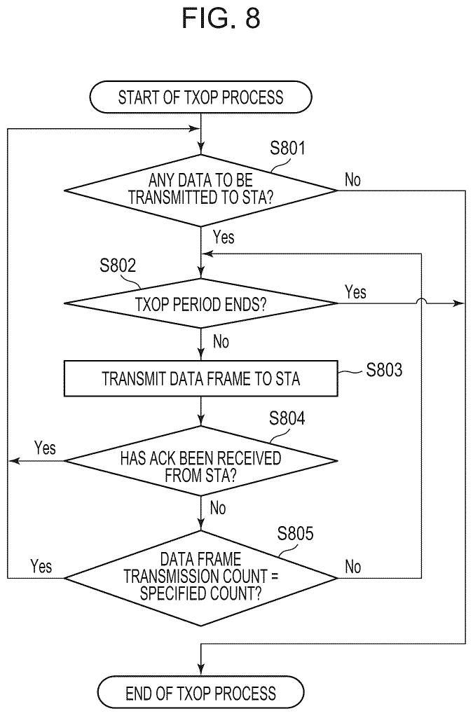

A detailed flowchart of S711 is illustrated in FIG. 8. This flowchart is initiated when the communication device 101, which is the AP, processes S711.

It is determined whether or not there is data to be transmitted to a STA even after the TXOP sharing period ends (S801).

In a case where it is determined in S801 that there is data to be transmitted to the STA, it is determined whether or not the TXOP period acquired by the AP has ended, (S802) and in a case where it is determined that the TXOP period acquired by the AP has ended, this flowchart ends.

In a case where it is determined in S802 that the TXOP period acquired by the AP has not ended, a data frame is transmitted to the STA (S803).

It is determined whether or not an ACK, which is a response frame for the data frame transmitted in S803, has been received from the STA (S804). In a case where it is determined in S804 that an ACK has not been received, it is determined whether or not the frame has been transmitted a predetermined number of times (S805). In a case where it is determined that the data frame has not been transmitted the predetermined number of times, the process returns to S802. In a case where it is determined that the data frame has been transmitted the predetermined number of times, the process returns to S801. The transmission count for the data frame in S805 may be set to be the same as that in S707 or may be set such that the specified count in S707 is smaller.

In a case where it is determined in S801 that there is no data to be transmitted to the STA, this flowchart ends.

According to the present embodiment, it is possible to confirm whether or not a STA to which the TXOP acquired by the AP is not allocated is ready for communication during the TXOP sharing period by transmitting a data frame to the STA. By confirming whether or not a STA to which a TXOP is not allocated is ready for data communication, for example, the STA can suppress packet loss of data frames from the AP.

### Other Embodiments

Note that a recording medium on which software program codes are recorded that realize the functions described above may be supplied to a system or device, and a computer (CPU, MPU) of the system or device may read out and execute the program codes stored in the recording medium. In this case, the program codes themselves, which are read out from the storage medium (which may also be referred to more fully as a “non-transitory computer-readable storage medium”), will realize the functions of the embodiment described above, and the storage medium storing the program codes will be included in the device described above.

For example, flexible disks, hard disks, optical disks, magneto-optical disks, CD-ROMs, CD-Rs, magnetic tapes, non-volatile memory cards, ROMs, and DVDs can be used as storage media to supply program codes.

In addition to the above-described functions being realized by the computer executing the read-out program codes, the OS running on the computer may also perform part or all of the actual processing on the basis of the instructions of the program codes to realize the functions described above. OS is an abbreviation for Operating System.

Furthermore, the program codes read out from the storage medium are written into a memory included in a function expansion board inserted into the computer or included in a function expansion unit connected to the computer. Then, on the basis of the instructions of the program codes, the CPU included in the function expansion board or function expansion unit may perform part or all of the actual processing to realize the functions described above.

The present invention can also be realized by performing processing in which a program that realizes one or more functions of the embodiments described above is supplied to a system or device via a network or storage medium and in which one or more processors in a computer of the system or device read out and execute the program. The present invention can also be realized by a circuit (for example, an ASIC) that realizes the one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device that operates in a role of establishing a wireless network, comprising:
at least one storage medium;
at least one processor that executes instructions stored in the at least one storage medium, at least one circuit, or a combination of the at least one processor and the circuit, to cause the communication device to perform:
transmitting a Trigger frame that allows at least one of other communication devices participating in the wireless network to share a first period and communicate, the Trigger frame being compliant with an IEEE 802.11 series standard, the first period being at least a portion of a Transmission Opportunity (TXOP) acquired by the communication device; and
confirming, by transmitting a confirmation frame, whether or not a first other communication device is ready for communication during the first period, the first other communication being included in the other communication devices that participate in the wireless network and being not allowed to share the first period by the transmitted Trigger frame,
wherein in a case where it is confirmed that the first other communication device is not ready for communication during the first period, a frame is not transmitted to the first other communication device during the first period.

2. The communication device according to claim 1, wherein the at least one processor, the at least one circuit, or the combination of the at least one processor and the circuit, further operates to cause the communication device to perform: receiving, from the first other communication device, a response frame for the confirmation frame,
wherein in a case where the response frame transmitted from the first other communication device is not received, the confirmation frame is retransmitted, and in a case where response frame reception has failed a predetermined number of times, the communication device confirms that the first other communication device is not ready for communication.

3. The communication device according to claim 1, wherein in a case where it is confirmed that the first other communication device is not ready for communication, the confirmation frame is transmitted to a second other communication device, which is different from the first other communication device and is not allowed to share the first period by the Trigger frame.

4. The communication device according to claim 2, wherein the confirmation frame is a data frame including data that the communication device transmits to the first other communication device.

5. The communication device according to claim 2, wherein the confirmation frame is a Null QOS Data frame.

6. The communication device according to claim 2, wherein the confirmation frame is an RTS frame.

7. A communication device comprising:
at least one storage medium;
at least one processor that executes instructions stored in the at least one storage medium, at least one circuit, or a combination of the at least one processor and the circuit, to cause the communication device to perform:
receiving a Trigger frame that allows at least one of communication devices participating in a wireless network to share a first period and communicate, the first period being at least a portion of a Transmission Opportunity (TXOP) acquired by another communication device playing a role of establishing the wireless network, the Trigger frame being compliant with an IEEE 802.11 series standard; and
transmitting, in a case where the communication device is not allowed to share the first period by the received Trigger frame, a response frame for a confirmation frame, which is transmitted from the other communication device, to the other communication device.

8. A communication method for a communication device that operates in a role of establishing a wireless network, comprising:
a transmission step for transmitting a Trigger frame that allows at least one of other communication devices participating in the wireless network to share a first period and communicate, the Trigger frame being compliant with an IEEE 802.11 series standard, the first period being at least a portion of a Transmission Opportunity (TXOP) acquired by the communication device; and
a confirmation step for confirming, by transmitting a confirmation frame, whether or not a first other communication device is ready for communication during the first period, the first other communication being included in the other communication devices that participate in the wireless network and being not allowed to share the first period by the Trigger frame transmitted in the transmission step,
wherein in a case where it is confirmed in the confirmation step that the first other communication device is not ready for communication during the first period, a frame is not transmitted to the first other communication device during the first period.

9. A communication method for a communication device, comprising:
a reception step for receiving a Trigger frame that allows at least one of communication devices participating in a wireless network to share a first period and communicate, the first period being at least a portion of a Transmission Opportunity (TXOP) acquired by another communication device playing a role of establishing the wireless network,
the Trigger frame being compliant with an IEEE 802.11 series standard; and
a transmission step for transmitting, in a case where the communication device is not allowed to share the first period by the Trigger frame received in the reception step, a response frame for a confirmation frame, which is transmitted from the other communication device, to the other communication device.

10. A non-transitory computer readable storage medium that stores a program to cause, when the program is executed, a communication device that operates in a role of establishing a wireless network to perform:
transmitting a Trigger frame that allows at least one of other communication devices participating in the wireless network to share a first period and communicate, the Trigger frame being compliant with an IEEE 802.11 series standard, the first period being at least a portion of a Transmission Opportunity (TXOP) acquired by the communication device; and
confirming, by transmitting a confirmation frame, whether or not a first other communication device is ready for communication during the first period, the first other communication being included in the other communication devices that participate in the wireless network and being not allowed to share the first period by the transmitted Trigger frame,
wherein in a case where it is confirmed that the first other communication device is not ready for communication during the first period, a frame is not transmitted to the first other communication device during the first period.

11. A non-transitory computer readable storage medium that stores a program to cause, when the program is executed, a communication device to perform:
receiving a Trigger frame that allows at least one of communication devices participating in a wireless network to share a first period and communicate, the first period being at least a portion of a Transmission Opportunity (TXOP) acquired by another communication device playing a role of establishing the wireless network, the Trigger frame being compliant with an IEEE 802.11 series standard; and
transmitting, in a case where the communication device is not allowed to share the first period by the received Trigger frame, a response frame for a confirmation frame, which is transmitted from the other communication device, to the other communication device.
